(19) United States
(12) Patent Application Publication
(10) Pub. No.: US 2006/0248863 A1
(43) Pub. Date: Nov. 9, 2006

(54) Device and saddle assembly

(76) Inventor: George Gorman, Ellon (GB)

Correspondence Address: TAFT, STETTINIUS & HOLLISTER LLP, SUITE 1800, 425 WALNUT STREET, CINCINNATI, OH, 45202-3957, US

(21) Appl. No.: 11/413,786

(22) Filed: Apr. 28, 2006

(30) Foreign Application Priority Data
May 3, 2005 (GB) 0508809.1

(51) Int. Cl. B68C 1/02

(52) U.S. Cl. 54/44.1

(57) ABSTRACT

A fall arrestor suitable for attachment to a saddle. The fall arrestor is held by a rider of a horse or the like and allows the rider to control and mitigate the danger when unseated from a horse. Exemplary embodiments include webbing configured in a Y-shape so that it can be connected to stirrup bars on opposite sides of a saddle which conveniently take the load of a fall. The device may also include sacrificial links and a rubber shock absorber to further control the fall.

### CROSS REFERENCE TO RELATED APPLICATIONS

This application claims the benefit under 35 U.S.C. §119 of United Kingdom Patent Application Serial No. 0508809.1, filed May 3, 2005, and entitled “Device and Saddle Assembly,” the disclosure of which is incorporated herein by reference.

### BACKGROUND OF THE INVENTION

1. Field of the Invention

The present invention relates to a device for breaking the fall of a rider from a horse or the like and a saddle assembly including a saddle equipped with such a device and a method for horse riding.

2. Description of the Related Art

Horse riding is a popular sport, but can be inherently dangerous if a horse unseats a rider, or the rider loses balance and falls from the horse. Serious injuries can result from such falls, particularly back and head injuries. It is generally accepted that riders should not be secured to animals to prevent them from falling, as this could be dangerous for the rider in the event that they lose control of the animal and it bolts under low lying branches for example, or if the rider is dragged behind the animal. Thus, riders are typically taught to let go and fall from a horse cleanly when they lose balance or when the horse bolts.

### SUMMARY OF THE INVENTION

According to a first exemplary aspect of the present invention there is provided a device for breaking a fall of a rider from a horse or the like, the device comprising at least one member having a first end portion and a second end portion, wherein the first end portion is connectable to a load bearing portion of a saddle and wherein the second end portion is capable of being gripped by a rider. In such an embodiment, either or both members can be a flexible member.

The device provides an aid for riders who fall from a horse or the like and enables the rider to make a more controlled and safer descent. In the event of a fall from an animal, use of the device enables the rider to maintain a semi-upright position. Since the second end portion is capable of being gripped by a rider, the head and back of the rider are more likely to be clear from the ground and the rider will be landed over the shoulder of the horse, which is safer.

The first end portion of either or both members can be arranged to be coupled to load bearing portions of the saddle at spaced apart locations.

The first end portion can be provided with connection means for connecting the device to the load bearing portion of the saddle.

The connection means can comprise two connectors for connecting the first end portion to the saddle in two separate locations. Thus the device can comprise one member and two connectors arranged in a Y-shaped configuration.

The first end portion connectable to the saddle is advantageous since any load applied to the device in use will be borne in a mid region on the back of the horse or the like.

Each connector can comprise a length of webbing. A smooth webbing material is advantageous since it will limit any pain experienced by the horse or the like if the webbing material comes into contact with the animal.

Each connector can comprise a fixing means. The fixing means can comprise an anchor tie for fixing the device to the load bearing portion of the saddle.

Each connector can be connectable to two load bearing portions of the saddle. The connectors can further comprise one or more links for coupling each member to the saddle in use, wherein the links are arranged to break on application of a predetermined force thereto.

Accordingly, these links are provided to act as sacrificial links in use, to dissipate some of the energy of the fall, since they are designed to break on application of a predetermined force. Therefore, when the device is in use, the links coupling the device and the saddle can be used to weaken the impact or force of the fall.

At least one member can be provided with a stop member. The stop member can comprise a rim protruding radially outwardly with respect to the or each member. The stop member can be arranged such that it is proximate to the second end portion. The stop member can be arranged to act as an impediment to prevent the device from slipping out of the rider's hand when in use.

A compressible member can be provided on the member, preferably in the region of the second end portion. The compressible member can be compressible by a rider, thereby acting as a shock absorber. Preferably the compressible member is compressible in an axial direction, the axial direction defined by the member.

A neck portion of the compressible member may be provided to encourage the compression of the compressible member, the neck portion having a smaller radius than a main part of the compressible member. The width and/or length of the neck portion can be varied to alter the compressive force required for deformation thereof. In general, the shorter axial length of the neck portion the less force required for compression and the longer axial length of the neck portion, the greater the force required for compression thereof.

Preferably, the compressible member is adapted to compress to a greater extent than the member. Preferably, the member is adapted to compress by a negligible extent.

The compressible member can comprise two or more portions, each shaped to compress on application of a predetermined load. The portions can be shaped to compress on application of different predetermined loads. Each shaped portion can comprise a neck portion.

The compressible member can be manufactured from compressible foam rubber.

The stop member can be provided as part of the compressible member, such that application of a force to the stop member causes compression of the compressible member, typically in an axial direction.

Preferably, the compressible member comprising the stop member has a bore through which the member extends.

The device can comprise two members provided adjacent each other which connect with at least one, preferably two pairs of adjacent connectors, each pair of connectors connectable to the saddle, such that in use, the connection between one member and the saddle will not be broken should another member or one connector break.

The length of each member can be adjustable. Each member can be provided with adjuster means. Thus the length of the device can be altered to suit the requirements of the rider or the nature of the riding they intend to do.

The device can be manufactured from synthetic rope.

According to a second exemplary aspect of the present invention, there is provided a saddle assembly comprising a saddle and a device for breaking a fall of a rider as described herein.

The saddle assembly is useful in conjunction with the usual horses tack. Reins are typically provided to be held by the rider for controlling the horse. However, the reins are not load bearing and move with the horse's head. The saddle assembly comprising the device attached to the saddle, is a separate, steady aid for a rider. Attaching the device to a load bearing portion of the saddle is advantageous as it represents the most stable position for the device and is likely to be the least damaging to the horse. The device is suitable for attachment to a standard English saddle.

Connector means can connect the member to load bearing portions of the saddle in spaced apart locations. Connector means preferably connect the member to stirrup bars provided on the saddle.

Two members can be coupled to the saddle in two spaced apart locations.

The device coupled to the saddle at two spaced apart locations can occupy a Y-shape. This has the advantage that when a rider falls, the horse carries a certain amount of the strain on its back without a part of the saddle to which the device is attached, such as the stirrup bar, from taking all the load of the falling rider.

The device can also be used to allow a rider to regain their balance. The device can also be used to allow a rider to control their descent on dismounting from the horse or the like.

The device is not limited to use on a horse, as it may be used on other animals such as a donkey, pony, etc.

The invention also provides a method of horse riding comprising gripping a device as described herein whilst riding.

The invention also provides a method for a rider to control a fall from a horse or the like, the method comprising the rider holding a device as described herein, the device being secured to a load bearing portion of a saddle on the horse, and in the event of the rider falling from the horse, maintaining hold of the device, allowing the device to take a portion of the weight of the rider, and releasing the device.

Preferably the method includes compressing the compressible member in order to cushion the fall, and more preferably allowing the sacrificial weak links to break before releasing the device.

Preferably the device also aids to orient the rider so that their head is uppermost and preferably so that they are less likely to land on their back or head.

Any feature of any aspect of any invention or embodiment described herein may be combined with any feature of any aspect of any other invention or embodiment described herein mutatis mutandis.

### BRIEF DESCRIPTION OF THE DRAWINGS

Embodiments of the present invention will now be described with reference to and as shown in the following drawings:

FIG. 1 is a top view of a device according to the first aspect of the present invention;

FIG. 2 is a top view of the device according to another embodiment of the first aspect of the present invention;

FIG. 3 is a side perspective view of a saddle assembly according to the second aspect of the present invention;

FIG. 4 is a side view of a shock absorber; and

FIG. 5 is a side perspective view of a saddle assembly according to a further embodiment of the present invention.

### DETAILED DESCRIPTION OF PREFERRED EMBODIMENTS

The exemplary embodiments of the present invention are described and illustrated below to encompass devices for breaking the fall of a rider from a horse or the like and a saddle assembly including a saddle equipped with such a device and a method for horse riding. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

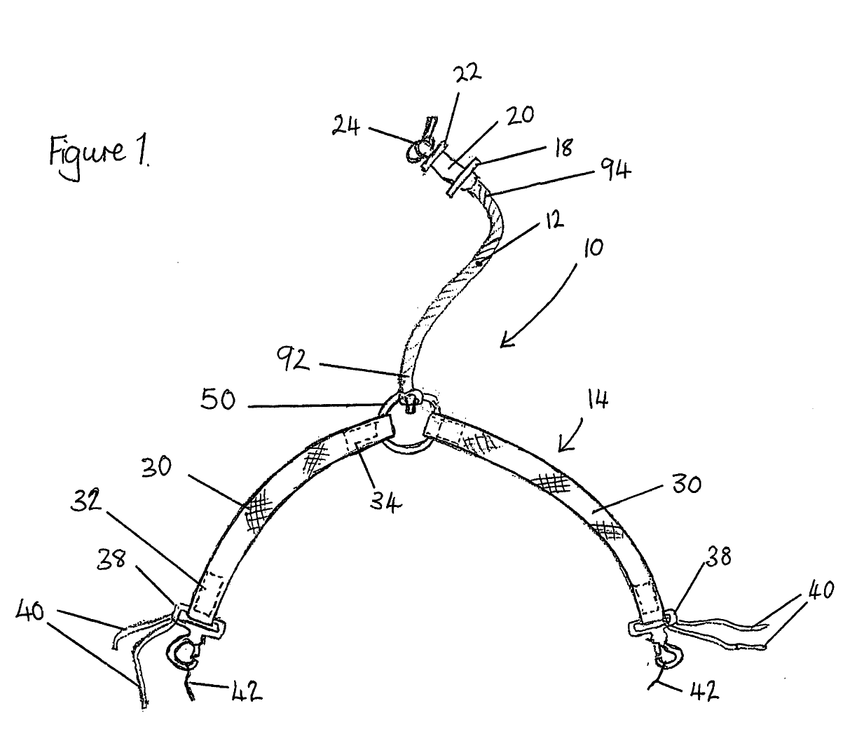

A device for breaking the fall of a rider (not shown) from a horse or the like is shown generally at 10 in FIGS. 1-3.

The device 10 of FIG. 1 comprises a flexible member 12 and connectors 14. The flexible member 12 has a first end portion 92 and a second end portion 94 that may be comprised of a synthetic rope, such as polyester.

Towards the second end portion 94 there is provided a hand stop 18 in the form of a rim extending radially outwardly relative to the flexible member 12. Similarly, an end stop 22 is provided in the form of a rigid rim extending radially outwardly and is prevented from sliding off the flexible member 12 by a knot 24. The hand stop 18 also comprises a shock absorber 20. The shock absorber 20 is positioned between the hand stop 18 and the end stop 22. According to this embodiment, the shock absorber 20 comprises a compressible foam rubber. Although, any form of compression device or material capable of deformation will be suitable for use as the shock absorber 20.

The first end portion 92 is tied to a metal ring 50. Also attached to the metal ring 50 are two strips of webbing 30. Each length of webbing 30 is attached to the ring 50 by means of a doubled over end portion 34 which is stitched to form an aperture (not shown). The aperture accommodates the metal ring 50. Similarly, an opposing end portion 32 is doubled over and stitched to create an aperture (not shown), which accommodates a spring-loaded clip 38. The spring-loaded clip 38 is provided with an anchor line 40 and a link 42 attached thereto. The anchor line 40 and the link 42 can be used for coupling the device 10 to a saddle. The anchor line 40 is attached to a load bearing portion of a saddle whereas the link 42 is attached to any suitable part of the saddle, as described in more detail below.

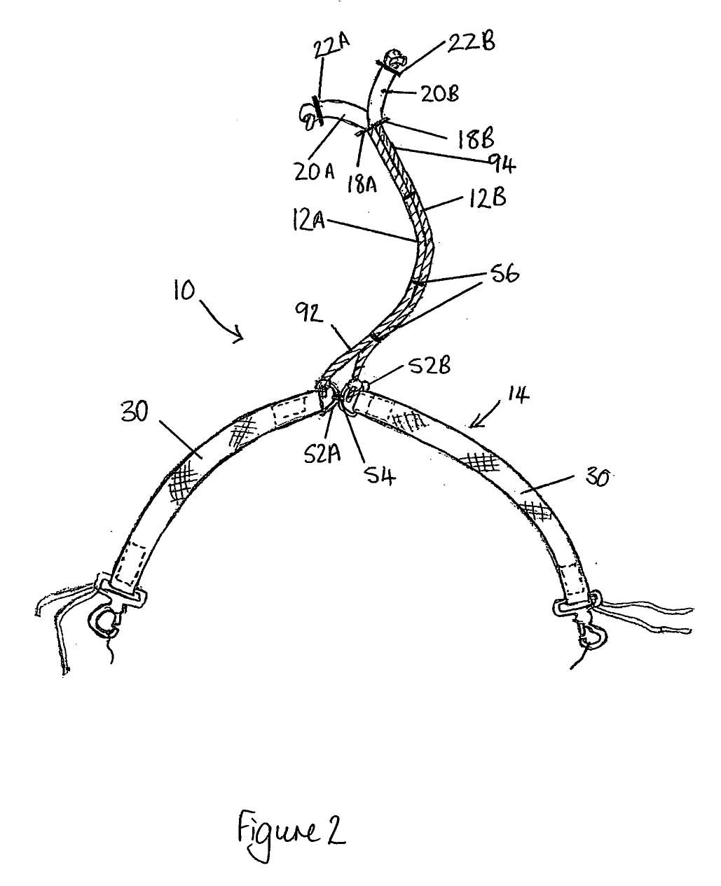

The device shown in FIG. 2 is similar to the FIG. 1 embodiment, but comprises two flexible lines 12A and 12B. Each line 12A, 12B is provided with a hand stop 18A, 18B, shock absorber 20A, 20B and end stop 22A, 22B towards the second end portion 94 as described for FIG. 1 above. Flexible lines 12A, 12B are coupled in adjacent relation using ties 56.

At the first end portion 92 the flexible lines 12A, 12B are each provided with a separate D-ring 52A, 52B. The D-rings 52A, 52B are joined by a tie 54. The connectors 14 are the same as those previously described for FIG. 1.

The advantage of the system such as that shown in FIG. 2 is that in the event of failure or breakage of any of the attachments coupling the device 10 to a saddle, there is an in-built system redundancy since there are effectively two devices independently attached at separate points to load bearing portions of the saddle. As shown in FIG. 2 these are coupled together to facilitate use of the device by the rider, while providing the system with in-built redundancy.

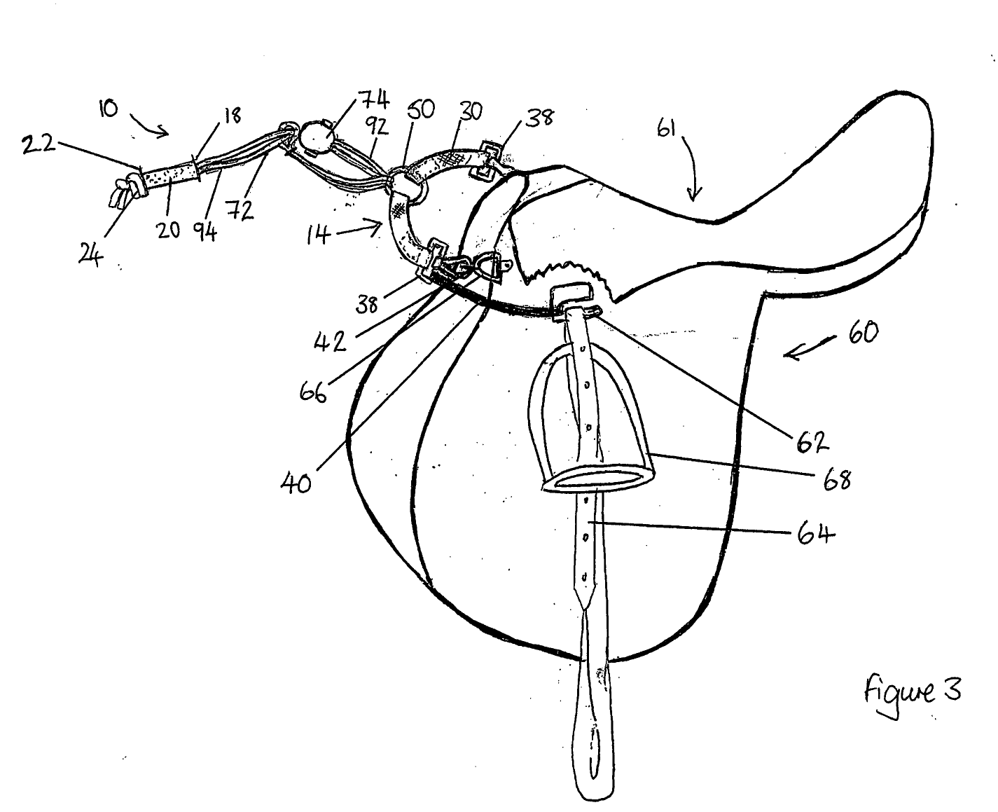

FIG. 3 shows a saddle indicated generally at 60 with the device 10 attached thereto by connectors 14. The saddle 60 has a seat portion 61 and is provided with two stirrup bars 62 secured to opposing sides of the saddle 60 on either side of the seat portion 61. The stirrup bars 62 are C-shaped and have leather straps 64 slotted therein for supporting stirrups 68. In use, each stirrup 68 accommodates a foot of the rider. Thus, each stirrup bar 62 to which the stirrup 68 is attached via the leather strap 64 is necessarily a load bearing part of the saddle 60.

Another advantage of the device 10 is that it can be used in conjunction with a traditional English saddle without modification thereof. As well as being load bearing portions of the saddle 60, the stirrup bars 62 are also adapted to cope with jolts experienced when a rider mounts a horse.

The device 10 shown in FIG. 3 comprises a flexible line 72 which is provided with a ball stop adjuster 74 for adjusting the length of the line 72. The anchor ties 40 secure the device 10 to the saddle 60. Each anchor tie 40 attaches directly to the corresponding stirrup bar 62. Links 42 are used to attach the spring-loaded clips 38 to D-rings 66, which D-rings 66 are fixed to the saddle 60.

The ties 40 and the links 42 used in the present embodiment are advantageous since they do not require modification of a standard English saddle 60. D-rings 66 are commonly provided on saddles. However, any other appropriate form of attachments or connectors 14 can be used.

Before use, the length of the flexible line 72 can be adjusted depending on the requirements of the rider. Adjustment of the flexible line 72 is achieved using the ball adjuster 74.

The rider can mount the saddle 60 in the usual manner and sit in the seat portion 61, while the rider's feet are accommodated in the stirrups 68. It is usual for the rider to hold reins (not shown) for controlling the movement of the horse or other animal. Notably, the reins are never attached to a load bearing part of the horse. The rider also holds the flexible member 72 in one hand.

In the event that the rider is dislodged from the seat portion 61 and begins to fall from the saddle 60, they can grasp firmly the device 10 in the region of the second end portion 94 of the flexible line 72. This is in contrast with the general teaching that a rider should let go as soon as they start to fall from an animal. The line 72 is more stable than the reins as the device 10 is attached to load bearing portions of the saddle 60 in a mid portion of the horse, whereas the reins are attached to, and therefore move with, the horses head.

If the rider's grip on the flexible member 72 slips as the rider falls, the rider's clenched hand will eventually abut the hand stop 18. The hand stop 18 prevents the device 10 from slipping out of the rider's grasp altogether. As the rider's hand abuts the hand stop 18, the shock absorber 20 between the hand stop 18 and end stop 22 will be at least partially compressed, thereby cushioning the rider's hand from a jolt experienced as the impact of the falling rider is taken up by the device 10 as it becomes taut, which reduces some of the initial impact of the fall.

Once sufficient force is applied to the connector means 14, for example, when the device 10 becomes taut, the links 42 attaching the spring loaded clip 38 to the D-ring 66 are arranged to break, further cushioning the fall of the rider and dissipating some of the energy associated with the fall.

Since the rider is holding onto the device 10, their body will tend to orientate during the fall so that their head is further from the ground than their legs or lower part of their body. This will also bring their back upright.

The rider can then let go of the device 10 and fall to the ground.

The device 10 allows a rider to fall in a graduated and controlled manner. The shock absorber 20 and sacrificial links 42 alleviate the sudden impact of the fall experienced by the hand and body of the rider. The hand stop 18 and material from which the flexible member 72 is manufactured can improve the rider's purchase on the device 10. The act of holding on to the device 10 maintains the rider's head and neck, at least partially upright and prevents the rider from falling head first from the horse.

A further advantage of the Y-shaped attachment when the device is coupled to the saddle as shown in FIG. 3, is that as the rider falls on one side of a horse, the webbing 30 of the connector means 14 is taut on the opposing side, thereby ensuring that the anchor tie 40, is acting on a central section of the C-shaped stirrup bar 62. This is achieved without the anchor tie 40 tending to slip off the stirrup bar 62 as the rider falls, which may be the case if the connectors 14 were not constrained on both sides of the seat portion 61 of the saddle 60. Additionally, the Y-shaped arrangement allows the horse's back to carry a proportion of the strain, so that it is not all carried by the stirrup bar 62.

The symmetrical nature of the Y-shaped attachment is advantageous since the device 10 defines an identical locus on each side of the saddle 60 within which it operates as a rider falls. Therefore the length of the device 10 can be accurately determined to suit the height of the rider. Alterations or adjustments to compensate for riders of a different weight and/or height are facilitated since the device 10 can be adjusted once to obtain an equal locus in which it operates on either side of the saddle 60.

The device 10 is designed not only to be weight bearing but is also designed with the ability to withstand the sudden impact when a rider falls. Furthermore, since the device 10 is attached to a load-bearing portion of the saddle 60, the device is very stable and reliable. Additionally, placement of the device 10 on a load bearing portion of the saddle 60 means that the rider will tend to fall behind the shoulder portion of the horse when using the device 10. This is safer for the rider as it reduces the risk of being trampled by the horse.

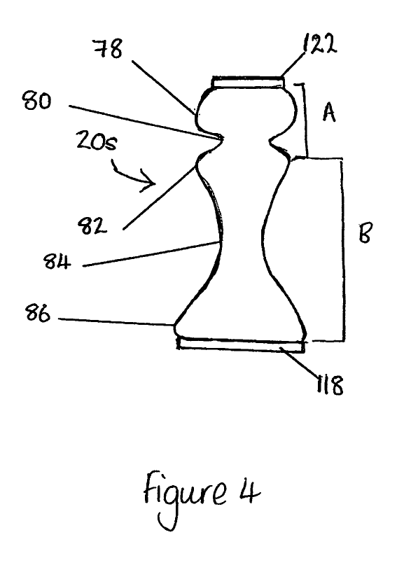

An alternative shock absorber 20s is shown in FIG. 4 with a hand stop 118 and an end stop 122 at respective ends thereof. The shock absorber 20s is provided with an axial throughbore (not shown) through which the member 12, 12A, 12B, 72 is accommodated. The shock absorber 20s is formed with a first shaped portion A and a second shaped portion B. Portion A has a narrow neck region 80 between an outer circumference 78 and an outer circumference 82. Portion B has a graduated neck region 84 between the outer circumference 82 and an outer circumference 86. Due to the narrow neck region 80 of the portion A, a smaller force is required to at least partially compress the neck region 80 between the outer circumference 78 and the outer circumference 82, than that required to compress the more graduated neck region 84. Thus, on application of a compressive force to the shock absorber 20s, the portion A initially at least partially compresses, while application of a greater force is required to at least partially compress portion B. As a result, the impact of the fall can be reduced in two stages; first by compression of portion A, followed by compression of portion B if sufficient force is applied. Thus, the graduated neck region 84 is arranged to cope with severe shocks and jolts.

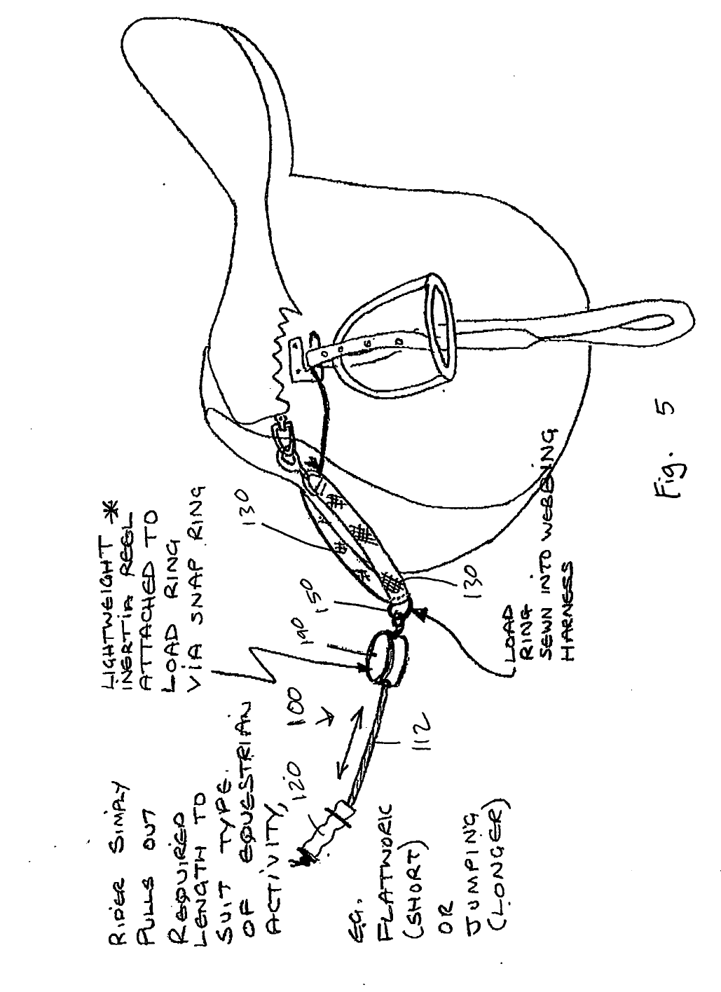

In FIG. 5, an inertia reel 190 is provided on a device 100 to allow the rider to pull out a required length of the flexible member 112. If the rider intends to jump with the horse then a longer length may be chosen compared to purely flat work with the horse which would ideally require a shorter length. In use, the inertia reel 190 will stop further extraction of the flexible member by known internal mechanisms. Inertia reels are available from a number of suppliers, for example: Lifting and Safety Services, Scunthorpe, UK; Warwick and Associates, Arizona, USA and Beaver Sales Pty Ltd, NSW, Australia. Other components shown in FIG. 5, including a shock absorber 120, webbing 130 and a ring 150 (sewn into the webbing) have a similar use as that described for earlier embodiments.

Modifications and improvements can be made without departing from the scope of the invention. For example an automatic release mechanism may be incorporated. This may be in the form of a further weak link which would break should an unseated rider be caught between a horse and some other immovable object and still try to hold on. However this is less preferred since the “weak” link would still need to be strong enough to cushion the fall of a rider. Alternatively the automatic release may be facilitated by a position release mechanism, for example by use of a slotted mechanism, which releases the device from the horse when in an orientation which corresponds with the rider having fallen from the horse.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A device for breaking a fall of a rider from a horse or the like, the device comprising at least one member having a first end portion and a second end portion, wherein the first end portion is connectable to a load bearing portion of a saddle and wherein the second end portion is capable of being gripped by a rider.

2. A device as claimed in claim 1, wherein the first end portion is provided with at least two connectors for connecting the device to load bearing portions of the saddle at two spaced apart locations.

3. A device as claimed in claim 1, comprising one member and two connectors arranged in a Y-shaped configuration.

4. A device as claimed in claim 1, further comprising at least one sacrificial link for coupling the device to the saddle.

5. A device as claimed in claim 1, comprising a compressible member which is compressible in an axial direction.

6. A device as claimed in claim 5, wherein the compressible member has a bore through which the member extends.

7. A device as claimed in claim 5, wherein the compressible member comprises a main body and a neck, the neck having a smaller radius than the main body.

8. A device as claimed in claim 1, wherein the compressible member comprises two or more body portions, each adapted to compress on application of a predetermined load, wherein the portions are shaped to compress on application of different predetermined loads.

9. A device as claimed in claim 1, wherein the at least one member comprises a stop member proximate to the second end portion protruding radially outwardly with respect to the member.

10. A device as claimed in claim 9, comprising a compressible member which is compressible in an axial direction and wherein the stop member is provided as part of the compressible member, such that application of a force to the stop member causes compression of the compressible member.

11. A device as claimed in claim 1, wherein the length of the or each member is user-adjustable.

12. A device as claimed in claim 1, comprising two members adjacent each other which connect with at least one pair, preferably two pairs, of adjacent connectors, each pair of connectors connectable to the saddle.

13. A saddle assembly comprising a saddle and a device for breaking a fall of a rider from a horse or the like, the device comprising at least one member having a first end portion and a second end portion, wherein the first end portion is connectable to a load bearing portion of a saddle and wherein the second end portion is capable of being gripped by a rider.

14. A saddle assembly as claimed in claim 13, wherein the device comprises connectors which connect the device to load bearing portions of the saddle in spaced apart locations.

15. A saddle assembly as claimed in claim 13 wherein connectors connect the member to stirrup bars provided on opposite sides of the saddle.

16. A saddle assembly as claimed in claim 13, wherein the device is connected to the saddle via sacrificial links.

17. A method for a rider to control a fall from a horse or the like, the method comprising:
orienting a device comprising at least one member having a first end portion and a second end portion, wherein the first end portion is connected to a load bearing portion of a saddle and wherein the second end portion is gripped by a rider.
maintaining hold of the device, in the event of the rider falling from the horse, to allow the device to take a portion of the weight of the rider; and
releasing the device, in the event of the rider falling from the horse, subsequent to the device taking a portion of the weight of the rider.

18. A method as claimed in claim 17, including that act of compressing a compressible member to mitigate impact on the rider when the device takes a portion of the weight of the rider during the fall.

19. A method as claimed in claim 17, including the act of allowing sacrificial weak links provided between the device and the horse to break before releasing the device.

20. A method of horse riding, the method comprising:
orienting a device comprising at least one member having a first end portion and a second end portion, wherein the first end portion is connected to a load bearing portion of a saddle and wherein the second end portion is gripped by a rider whilst riding.
